(19) United States
(12) Patent Application Publication
(10) Pub. No.: US 2009/0102178 A1
(43) Pub. Date: Apr. 23, 2009

(54) Foam Book with Puzzle Pieces

(75) Inventor: Kim Thompson, Cuyahoga Falls, OH (US)

Correspondence Address: BROUSE MCDOWELL LPA, 388 SOUTH MAIN STREET, SUITE 500, AKRON, OH, 44311, US

(73) Assignee: TWIN SISTERS PRODUCTIONS, LLC, Stow, OH (US)

(21) Appl. No.: 12/030,573

(22) Filed: Feb. 13, 2008

Related U.S. Application Data
(60) Provisional application No. 60/980,589, filed on Oct. 17, 2007.

(51) Int. Cl. B42D 1/00

(52) U.S. Cl. 281/38

(57) ABSTRACT

A children's book may have a cover page, a non-cover page, a back cover page, and a binding portion. The cover page and the non-cover page may be made of a foam material and the back cover page may be made of a material other than foam. The binding portion may serve to bind all of the pages of the children's book together and allow for the opening and closing of the pages with respect to each other.

This application claims priority to U.S. Ser. No. 60/980,589 titled FOAM BOOK WITH PUZZLE PIECES, filed Oct. 17, 2007, which is herein incorporated by reference in its entirety.

### I. BACKGROUND OF THE INVENTION

A. Field of Invention

This invention pertains to the art of methods and apparatuses concerning books, and more particularly to the art of methods and apparatuses concerning children's books having foam portions and having puzzle pieces.

B. Description of the Related Art

It is well known to produce a book that includes a front cover (which may be considered a front cover page), a back cover (which may be considered a back cover page), and at least one non-cover page positioned between the front and back cover pages. Commonly, the book will contain a binding portion that serves to bind all of the pages of the book together and permits the pages to be opened and closed with respect to each other. Traditionally, books are produced utilizing paper for the non-cover pages and a heavier paper or a cardboard for the front and back cover pages.

It is also known to utilize a material other than paper for the pages of children's books. Children's books typically include books designed for younger children that have not yet learned to read or are reading at a rudimentary level. Typically, children's books incorporate the learning of other subjects such as shapes, colors, sizes, and other elementary skills, along with reading, into the book. It is known for children's books to include puzzle pieces or replaceable objects that a child may insert or place into a cut-out portion contained within the pages of the children's book. These puzzle pieces or replaceable objects may assist or reinforce the child's learning of a particular subject or skill. For example, each replaceable object and the respective cut-out portion may have substantially the same shape thereby allowing the child to additionally develop his or her shape recognition skills.

For example, it is known to have a children's or soft book where the front cover, back cover, and non-cover pages are made of a foam material. Each page may also have a perimeter. The perimeter may also be made of a foam material in order to provide a softer edge to the pages. A flexible, supportive material such as laminated paperboard may bind the pages of the children's book.

It is known to design a children's book that facilitates a child's learning and development through having an adult read to and assist the child as well as through having the child read (or look through) the book individually. Often, children will subject a book to certain physical stresses that differ from the common physical stresses a book may be subjected to by an adult reader. Children are more likely to chew, tear, wrinkle, and in other ways mar the pages of a book. By utilizing a material other than paper for the pages of a book, the book can be designed to withstand the unique physical stresses a child may inflict while still providing a means for learning additional skills such as counting, identifying colors, and other elementary skills.

Although known children's books work well for their intended purpose, several disadvantages exist. It is known to make children's books having pages made from a cloth material. The cloth material is typically subject to a greater amount of staining and soiling due to its permeable nature. Staining and soiling of the cloth material may increase the frequency of germs or viruses being passed to the child. Methods and techniques for reducing the amount of staining and soiling of the cloth material may often pose additional disadvantages specific to the method or technique employed.

Children's books where all of the book's pages, front cover page, back cover page, and non-cover pages, are composed of a foam material, are unnecessarily bulky and limit the level and amount of additional learning skills that may be incorporated into the book. The absence of even a single page being comprised of a material similar to that of paper, paperboard, or laminated paperboard, prevents the child from developing skills associated with books designed for older readers. For example, a child's fingers and hands cannot develop the dexterity and control necessary to manipulate a thinner page made of paper, paperboard, or laminated paperboard, nor can the child be instructed on the proper handling of such pages. A children's book having every page comprised of a foam material unnecessarily limits and stunts a child's potential for growth and development.

What is needed then is a children's book that is able to sustain the unique physical stresses inflicted upon a book by a child while still providing the child the opportunity to grow and develop the skills necessary in handling and caring for books designed for older readers.

### II. SUMMARY OF THE INVENTION

Some embodiments can include a book having a front cover page substantially comprised of foam polymer; a back cover page substantially comprised of a material other than foam polymer; at least a first non-cover page substantially comprised of foam polymer, wherein the at least a first non-cover page is positioned between the front cover page and the back cover page; and, a binding portion comprising: a first binding segment attached to the front cover page and the at least a first non-cover page thereby pivotally coupling the front cover page and the at least a first non-cover page to each other, wherein the first binding segment comprises a first segment first end and a first segment second end, wherein the first segment first end extends across a majority of the front cover page thereby defining a first foam polymer perimeter and the first segment second end extends across a majority of the at least a first non-cover page thereby defining a second foam polymer perimeter; a second binding segment attached to the back cover page and the at least a first non-cover page thereby pivotally coupling the back cover page and the at least a first non-cover page to each other, wherein the second binding segment comprises a second segment first end and a second segment second end, wherein the second segment first end extends across a majority of the at least a first non-cover page thereby defining a third foam polymer perimeter and the second segment second end extends across a majority of the back cover page thereby defining a first non-foam polymer perimeter; and, a third binding segment attached to the front cover page and to the back cover page thereby pivotally coupling the front cover page and the back cover page to each other, wherein the third binding segment comprises a third segment first end and a third segment second end, wherein the third segment first end extends across a majority of the front cover page thereby defining a fourth foam polymer perimeter and the third segment second end extends across a majority of the back cover page thereby defining a second non-foam polymer perimeter.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a children's book according to one embodiment of the invention;

FIG. 2 is a perspective top view of a children's book shown in a closed position according to one embodiment of the invention;

FIG. 3 is a partial assembly view of a children's book according to one embodiment of the invention;

FIG. 4 is a perspective top view of a children's book according to one embodiment of the invention;

FIG. 5 is a side view of a children's book in an open position showing a cut-out portion and a replaceable object according to one embodiment of the invention;

FIG. 6 is a perspective view of a children's book in a closed position showing a cut-out portion and a replaceable object according to one embodiment of the invention; and

FIG. 7 is a perspective view of a children's book in a closed position comprising a plurality of replaceable objects according to one embodiment of the invention.

### IV. DETAILED DESCRIPTION OF THE INVENTION

The present invention provides a children's book suitable for enduring the unique physical stresses that may be inflicted upon it by while also providing the child the opportunity to grow and develop the motor skills necessary for the proper handling of books designed primarily for older or adult readers. The inventive children's book may combine thick, durable pages that may be comprised of a foam polymer with pages similar to those found in books designed for older readers.

Some embodiments can include a front cover page, a back cover page, one or more non-cover pages disposed between the front and back cover pages, and one or more binding elements for holding the pages together in the form of a book. In one embodiment the front cover page substantially comprises a foam polymer. The foam polymer can comprise any of a wide variety of materials known to those skilled in the art, which are relatively soft, non-toxic, and suitable for young children. Some embodiments include a back cover page comprised of a material other than foam polymer. Further, in some embodiments the back cover page may be substantially thinner than the front cover page. For example, suitable back cover pages can include one or more of paper, paper board, card board, or card stock. Suitable back cover pages can also be laminated or otherwise coated to render the material more durable, and/or to enable the use of dry erase writing instruments.

With further regard to the back cover page, in some embodiments the back cover page can comprise a layered structure having a plurality of layers or a single layer. For example, some embodiments can comprise a polymer material suitable for use with dry erase writing instruments. Such polymer material can comprise the back cover page as a single layer, or can be coated or laminated onto one or more sides of another material, such as paper board, thereby rendering the other material suitable for use with dry erase writing instruments and rendering it more resistant to wear. In still other embodiments, the back cover page can comprise more than three layers. For example, the back cover page could comprise a plurality of layers of paper board coated on one or more sides with a polymer suitable for use with dry erase writing instruments.

In some embodiments the one or more binding elements can comprise, for example, a spine. The spine can be disposed along one edge of an assembly of pages. In some embodiments the spine can be attached to at least the front and back cover pages. Furthermore, in some embodiments, the spine may also include one or more portions that extend onto and/or over a portion of the surface of the front cover page, the back cover page, or both the front and back cover pages and may be in a bonded relation to such pages. Still further, in some embodiments, the spine can include a portion that extends to form a cover page, such as a back cover page. For example, in one embodiment one side of the spine extends onto and/or over a substantial portion of a front cover page and attaches to such front cover page in a bonding relation. An opposing side of the spine extends from the spine and forms a back cover page. According to such embodiments, the back cover page comprises a material similar to that of the spine, although it may include other elements not found in the spine.

According to some embodiments, one or more of the pages can comprise a colored material, such as a colored foam polymer. In some embodiments the pages can be the same color, and in other embodiments one or more of the pages can be different colors. Furthermore, in embodiments where one or more of the pages comprise different colors the colors can be arranged in any of a wide variety of patterns or can be randomly arranged. Although a wide variety of colors and arrangements thereof are within the scope of the present invention, some colors can include primary colors, pastel colors, bright or fluorescent colors, and the like.

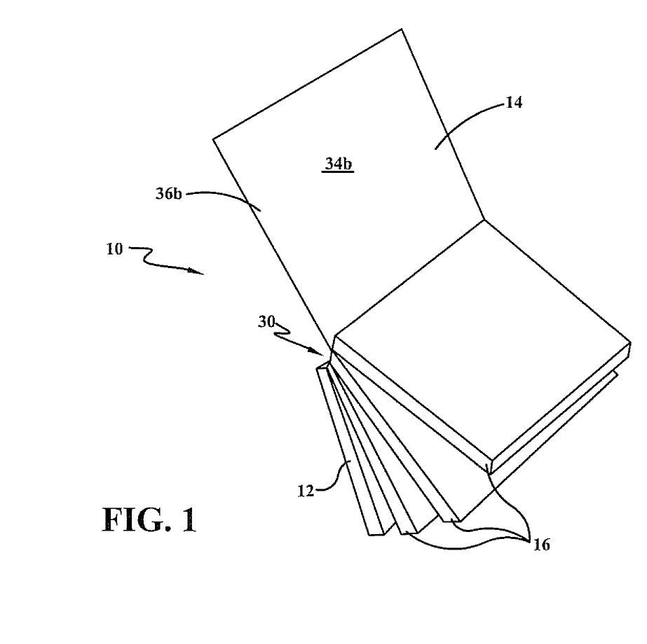

Referring now to the drawings wherein the showings are for purposes of illustrating embodiments of the invention only and not for purposes of limiting the same, FIG. 1 shows a children's book 10 comprising a front cover page 12, a back cover page 14, at least a first non-cover page 16, and a binding portion 30. The front cover page 12 and the at least a first non-cover page 16 may be substantially comprised of a foam polymer material such as ethyl vinyl acetate (EVA). The front cover page 12 and the at least first non-cover page 16 may comprise either high density or low density EVA. The front cover page 12 and the at least a first non-cover page 16 may be substantially comprised of any of a variety of foam polymer materials known to one ordinary skill in the art. The back cover page 14 may be substantially comprised of a material other than foam. In one embodiment of the invention, the back cover page 14 may be comprised of a laminated paperboard. In other embodiments, the back cover page 14 may be comprised of a paperboard, a cloth, or an organic polymer such as Kevlar.

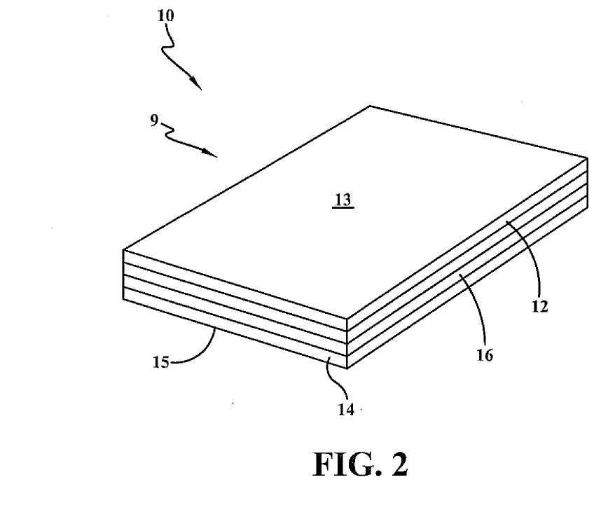

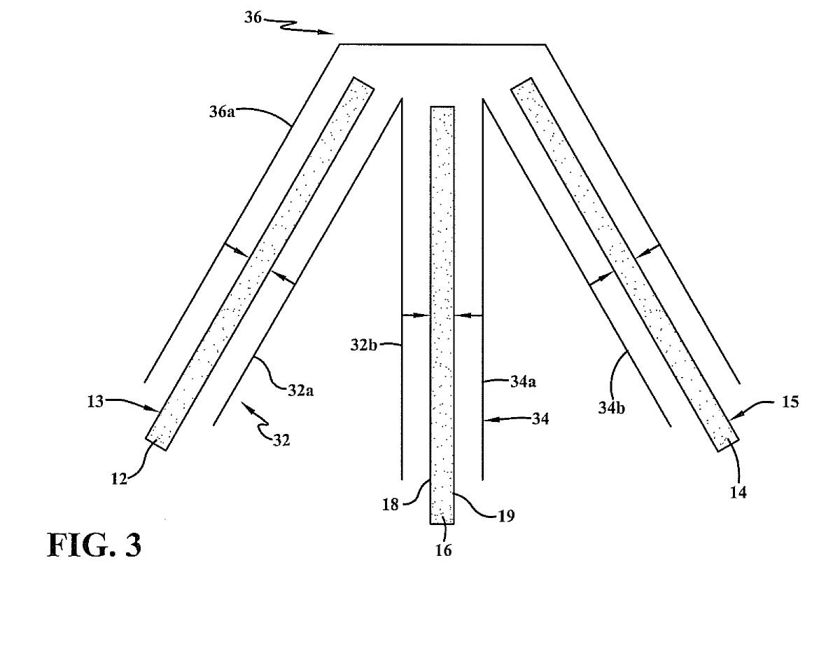

With reference now to FIGS. 1-3, the front cover page 12 may comprise a first outer surface 13 of the children's book 10 when the children's book 10 is in a filly closed position 9 (as shown in FIG. 2). The back cover page 14 may comprise a second outer surface 15 of the children's book 10 when the children's book 10 is in the fully closed position 9. The at least a first non-cover page 16 may comprise a first page surface 18 and a second page surface 19. The at least a first non-cover page 16 may be positioned between the front cover page 12 and the back cover page 14 such that the first page surface 18 abuts the front cover page 12 and the second page surface 19 abuts the back cover page 14. In another embodiment of the invention, the children's book 10 may comprise a plurality of non-cover pages. For example, the children's book 10 may comprise the at least a first non-cover page 16, a second non-cover page 20, a third non-cover page 22, and a fourth non-cover page 24. In other embodiments of the invention, the children's book 10 may comprise a plurality of non-cover pages wherein the plurality of non-cover pages may range from two non-cover pages to about twenty-five non-cover pages. In other embodiments of the invention, the children's book 10 may comprise a plurality of non-cover pages wherein the plurality of non-cover pages may range from five non-cover pages to about ten non-cover pages. The children's book 10 may comprise any number of non-cover pages chosen with sound judgment by a person of ordinary skill in the art. The plurality of non-cover pages may also be comprised of a foam polymer material and may similarly be positioned between the front cover page 12 and the back cover page 14.

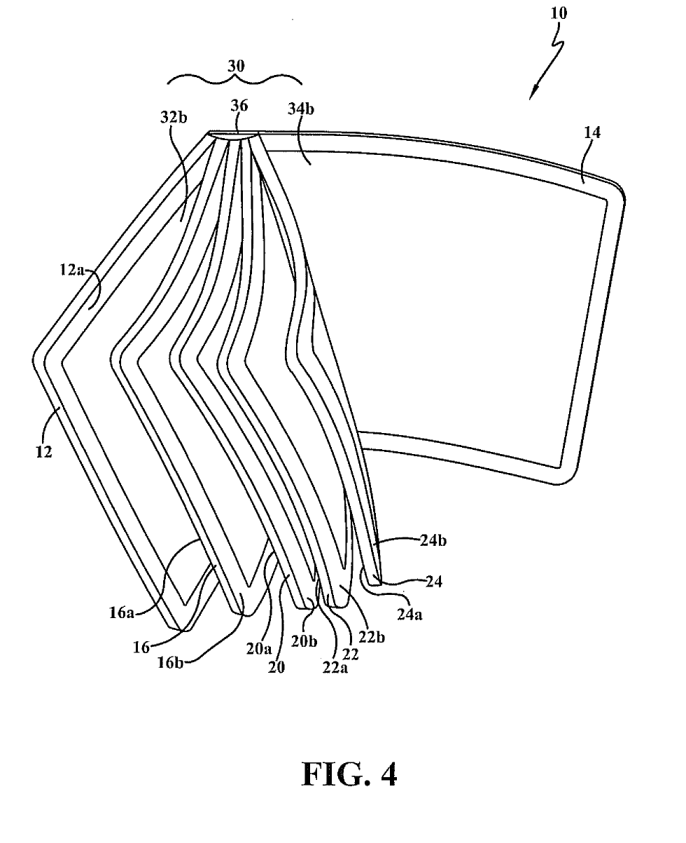

With reference now to FIGS. 1-4, the front cover page 12 and the plurality of non-cover pages 16, 20, 22, 24 may each comprise a colored foam polymer material. In one embodiment of the invention, the front cover page 12 and the plurality of non-cover pages 16, 20, 22, 24 may each comprise a colored foam polymer chosen from the group consisting of: red, blue, yellow, green, or purple. In yet another embodiment of the invention, the front cover page 12 and the plurality of non-cover pages 16, 20, 22, 24 may each comprise a different colored foam polymer chosen from the group consisting of: red, blue, yellow, green, or purple. For example, in one embodiment of the invention, the front cover page 12 may comprise a red colored foam; the at least a first non-cover page 16 may comprise a blue colored foam, the second non-cover page 20 may comprise a yellow colored foam, the third non-cover page 22 may comprise a green colored foam, and the fourth non-cover page 24 may comprise a purple colored foam. The differing colored foam pages 12, 16, 20, 22, 24 allow for the emphasis of the skills being taught by the children's book 10. For example, in one embodiment of the invention, the children's book 10 may provide instruction on learning various colors and the differing colored foam polymer pages 12, 16, 20, 22, 24 may provide additional emphasis or support for the teaching contained in the writing. The children's book 10 may comprise any variation of colored foam polymer pages chosen with sound judgment by one of ordinary skill in the art.

With reference now to FIGS. 1-3, the binding portion 30 may generally be described. The binding portion 30 will be described with respect to only the front cover page 12, the at least a first non-cover page 16, and the back cover page 14 as the use of binding portions is well known in the art. The binding portion 30 may comprise a first binding segment 32, a second binding segment 34, and a third binding segment 36. The binding segments 32, 34, and 36 may each comprise a flexible and supportive material such as paperboard or laminated paperboard and each binding segments 32, 34, and 36 may have a rectangular shape. The binding segments 32, 34, and 36 may each be comprised of the same material, or, alternatively, the binding segments 32, 34, and 36 may each be comprised of different materials with respect to each other. In one embodiment of the invention, the first binding segment 32 and the second binding segment 34 may comprise a laminated paperboard and the third binding segment 36 may comprise a thermoplastic material.

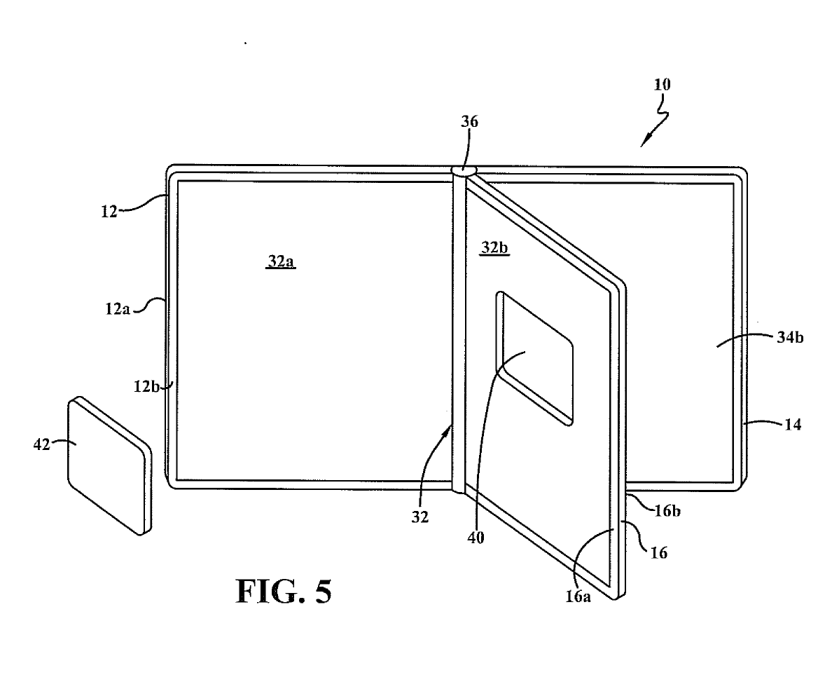

With reference now to FIGS. 1, 3-5, the binding segments 32, 34, and 36 may extend over a majority of, but not completely across, the respective page surfaces. In one embodiment of the invention, the first binding segment 32 may comprise a rectangular shape comprising a first end 32a and a second end 32b. The first end 32a may extend across a majority of the front cover page 12 thereby defining a first foam polymer perimeter 12a (shown in FIG. 5). The second end 32b of the first binding segment 32 may extend across a majority of the at least a first non-cover page 16 thereby defining a second foam polymer perimeter 16a (shown in FIG. 5). The second binding segment 34 may also comprise a first end 34a and a second end 34b. The first end 34a may extend across a majority of the at least a first non-cover page 16 thereby defining a third foam polymer perimeter 16b (shown in FIG. 5). The second foam polymer perimeter 16a and the third foam polymer perimeter 16b may be located on opposite sides of the at least a first non-cover page 16. The second end 34b of the second binding segment 34 may extend across a majority of the back cover page 14 thereby defining a first non-foam polymer perimeter 16a (shown in FIG. 5). The third binding segment 36 may comprise a first end 36a and a second end 36b. The first end 36a may extend across a majority of the front cover page 12 thereby defining a fourth foam polymer perimeter 12b (shown in FIG. 5). The fourth foam polymer perimeter 12b and the first foam polymer perimeter 12a may be located on opposite sides of the front cover page 12. The second end 36b of the third binding segment 36 may extend across a majority of the back cover page 14 thereby defining a second non-foam polymer perimeter 14b (shown in FIG. 5). The first and second non-foam polymer perimeters 14a, 14b may be located on opposite sides of the back cover page 14. In another embodiment of the invention, the second end 34b of the second binding segment 34 may be coupled to the second end 36b of the third binding segment 36 thereby comprising the back cover page 14 (shown in FIG. 1).

With continued reference to FIGS. 1, 3-5, the first binding segment 32 may be attached to the front cover page 12 and to the at least a first non-cover page 16 thereby pivotally coupling the front cover page 12 and the at least a first non-cover page 16 to each other. The second binding segment 34 may be attached to the back cover page 14 and to the at least a first non-cover page 16 thereby pivotally coupling the back cover page 14 and the at least a first non-cover page 16 to each other. The third binding segment 36 may be attached to the front cover page 12 and the back cover page 14. The third binding segment 36 may at least partially serve to bind all of the pages of the children's book 10 together and allow for the opening and the closing of the pages with respect to each other. In one embodiment of the invention, the first binding segment 32 and the second binding segment 34 may not be attached to the third binding segment 36. In one embodiment of the invention, the binding segments 32, 34, 36 may be coupled to the front cover page 12, the at least a first non-cover page 16, and the back cover page 14 using an adhesive. In another embodiment of the invention, the binding segments 32, 34,36 may be coupled to the front cover page 12, the at least a first non-cover page 16, and the back cover page 14 using a staple or other conventional fastener. The binding segments 32, 34, 36 may be coupled to the front cover page 12, the at least a first non-cover page 16, and the back cover page 14 using any method chosen with sound judgment by a person of ordinary skill in the art.

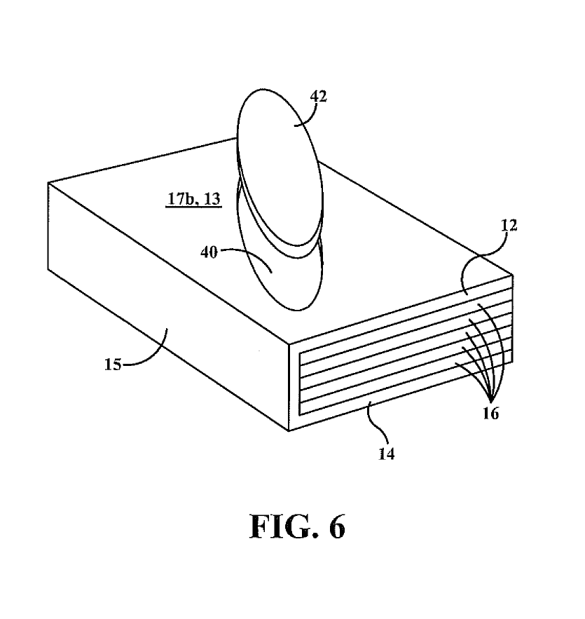

With reference now to FIGS. 5-6, the front cover page 12, the back cover page 14, and the at least a first non-cover page 16 may each comprise a first erasable writing surface 17a. Additionally, the front cover page 12, the back cover page 14, and the at least a first non-cover page 16 may each comprise a second erasable writing surface 17b. In other embodiments of the invention, one, all or none of the pages 12, 14, 16 may comprise either a first or a second erasable writing surface. For example, the front cover page 12 may comprise the first erasable writing surface 17a (shown in FIG. 5) and the second erasable writing surface 17b (shown in FIG. 6). The erasable writing surfaces 17a, 17b may comprise a laminated paperboard and may extend across a majority of the respective pages. In one embodiment of the invention, the children's book 10 may comprise a first erasable writing surface 17a that extends across substantially the same area as the first segment first end 32a and a second erasable writing surface 17b that extends across substantially the same area as the third segment first end 36a.

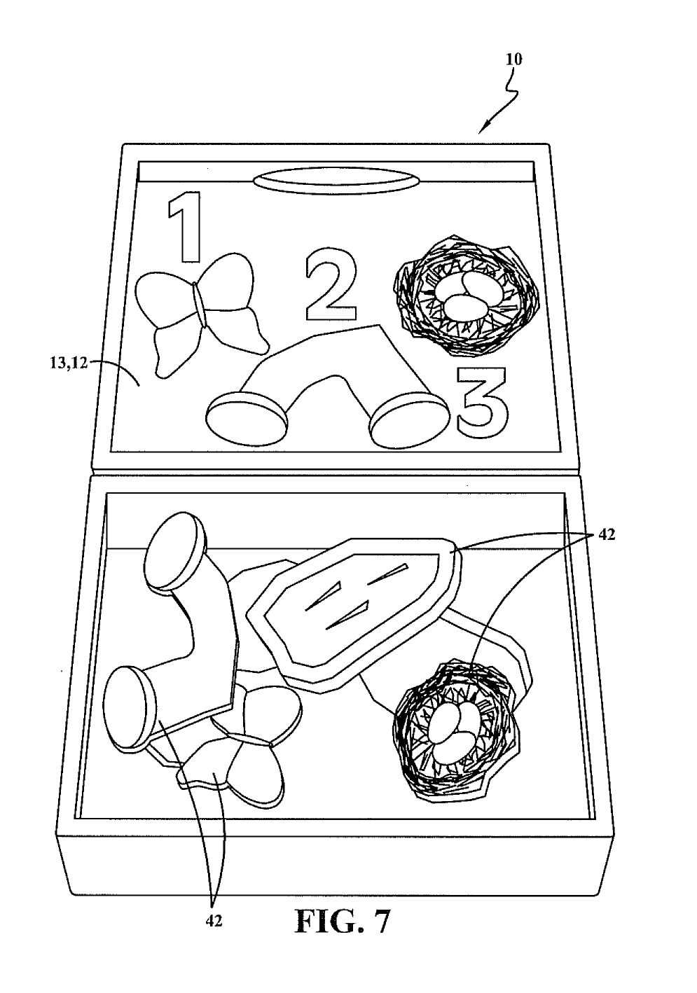

With reference now to FIGS. 1, 5-7, the first non-cover page 16 may comprise a cut-out portion 40. The cut-out portion 40 may be suitable for receiving a puzzle piece or replaceable object 42. The replaceable object 42 may be comprised of a foam polymer material and may be substantially similar in shape to the cut-out portion 40. In one embodiment of the invention, the replaceable object 42 may be cut out of or otherwise removed from the first non-cover page 16 thereby forming the cut-out portion 40 and the replaceable object 42. The cut-out portion 40 and the corresponding replaceable object 42 may comprise any size or shape chosen with sound judgment by a person of ordinary skill in the art. In other embodiments of the invention, the children's book 10 may comprise a plurality of cut-out portions 40 and a plurality of corresponding replaceable objects 42. The number and location of cut-out portions 40 and their corresponding replaceable objects 42 may be any number and located on any page of the children's book 10 chosen with sound judgment by a person of ordinary skill in the art. Optionally, the replaceable object 42 may be comprised of a colored foam polymer. In one embodiment of the invention, the replaceable object may be comprised of a colored foam polymer wherein the color is selected from the group consisting of: red, blue, yellow, green, or purple. The replaceable object 42 may comprise the same or a different colored foam polymer from the page of the children's book 10 in which the cut-out portion 40 is located.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

I/We claim:

1. A children's book comprising:
a front cover page substantially comprised of foam polymer;
a back cover page substantially comprised of a material other than foam polymer;
at least one non-cover page substantially comprised of foam polymer, wherein the at least one non-cover page is disposed between the front cover page and the back cover page; and,
a binding portion comprising:
a first binding segment attached to the front cover page and the at least one non-cover page thereby pivotally coupling the front cover page and the at least one non-cover page to each other, wherein the first binding segment comprises a first segment first end and a first segment second end, wherein the first segment first end extends across a majority of the front cover page thereby defining a first foam polymer perimeter and the first segment second end extends across a majority of the at least one non-cover page thereby defining a second foam polymer perimeter;
a second binding segment attached to the back cover page and the at least one non-cover page thereby pivotally coupling the back cover page and the at least one non-cover page to each other, wherein the second binding segment comprises a second segment first end and a second segment second end, wherein the second segment first end extends across a majority of the at least one non-cover page thereby defining a third foam polymer perimeter and the second segment second end extends across a majority of the back cover page thereby defining a first non-foam polymer perimeter; and,
a third binding segment attached to the front cover page and to the back cover page thereby pivotally coupling the front cover page and the back cover page to each other, wherein the third binding segment comprises a third segment first end and a third segment second end, wherein the third segment first end extends across a majority of the front cover page thereby defining a fourth foam polymer perimeter and the third segment second end extends across at least a majority of the back cover page.

2. The children's book of claim 1, wherein the at least one non-cover page comprises a cut-out portion and a replaceable object, wherein the cut-out portion is suitable for receiving the replaceable object.

3. The children's book of claim 2, wherein the replaceable object comprises a foam polymer.

4. The children's book of claim 1, wherein one or more of the back cover page, front cover page, at least one non-cover page, first segment first end, first segment second end, second segment first end, second segment second end, third segment first end, or third segment second end, further comprises an erasable writing surface.

5. The children's book of claim 1, wherein the front cover page further comprises a cut-out portion and a replaceable object, wherein the cut-out portion is suitable for receiving the replaceable object.

6. The children's book of claim 5, wherein the replaceable object comprises a foam polymer.

7. The children's book of claim 1, further comprising a plurality of non-cover pages comprised of foam polymer.

8. The children's book of claim 7, wherein the front cover page and the cover pages and the plurality of non-cover pages each comprises a colored foam polymer.

9. The foam polymer of claim 8, wherein the color of each page is independently selected from the group consisting of: primary colors, pastel colors, and fluorescent colors.

10. The children's book of claim 1, wherein the back cover page comprises a material selected from the group consisting of paper board, card board, card stock, and non-foam polymer.

11. The children's book of claim 10, wherein the back cover page comprises a plurality of layers.

12. The children's book of claim 11, wherein the back cover page comprises paper board coated with a polymer material on at least one side.

13. The children's book of claim 12, wherein the back cover page comprises laminated paper board.

14. A process for making a children's book, comprising the steps of:
fabricating a front cover page comprised of foam polymer;
fabricating at least one non-cover page comprised of foam polymer;
fabricating a back cover page comprised of one or more materials not including foam polymer;
arranging the pages so that the at least one non cover page is disposed between the front cover page and the back cover page; and
binding the pages with at least one binding element.

15. A children's book, comprising:
a means for covering a front of a plurality of pages;
a means for covering a back of a plurality of pages;
a means for defining an interior of a book; and
a means for binding each of the foregoing means together.
